(19) United States
(12) Patent Application Publication
(10) Pub. No.: US 2024/0378939 A1
(43) Pub. Date: Nov. 14, 2024

(54) AN INTERACTIVE DEVICE

(71) Applicant: Zytronics Displays Limited, Tyne and Wear (GB)

(72) Inventors: Andrew Morrison, Tyne and Wear (GB); Philip Andrew Rudland, Tyne and Wear (GB)

(21) Appl. No.: 18/696,625

(22) PCT Filed: Sep. 9, 2022
(86) PCT No.: PCT/GB2022/052299

§ 371 Date: Mar. 28, 2024

(30) Foreign Application Priority Data
Oct. 1, 2021 (GB) 2114121.3

(51) Int. Cl. G07F 17/32; G06F 3/041; G06F 3/044

(52) U.S. Cl. CPC G07F 17/3209; G06F 3/0412; G06F 3/044; G07F 17/3211

(57) ABSTRACT

An interactive gaming device (100) comprises a base display element (110) with sensors to detect a user touch, a transparent dome shaped user interaction element (120), and a control element. The user interaction element (120) is fixedly attached to the base display element (110). Part of the user interaction element (120) protrudes outwardly from the surface of the base display clement (110). The control element detects a user touch by determining a change in capacitance by comparing averaged signal values from the sensors to pre-defined threshold values.

The present invention relates to an interactive device having a display and facilitating control by user touch. In particular, but not exclusively, the present invention relates to an interactive gaming device.

Touch screen sensors are utilised in a variety of devices in order to facilitate user interaction with said device, for example in digital gaming devices such as in a casino environment. Conventionally, Projected Capacitive (PCap) touch sensors are manufactured with a flat glass front that faces the user. The user interacts with the device via touch sensors mounted in front of an LCD display. Known digital gaming devices include a button deck area with a touch sensor integrated in front of an LCD display and a mechanical “bash” button switch. The “bash” button switch is used by the user to interact with the game running on the device. Users generally like the feel of such “bash” button switches as they provide an interactive location area of the gaming device and provide tactile feedback when placing a final bet and interacting with the game.

It is an aim of the present invention to at least partly mitigate one or more problems of conventional digital gaming devices.

It is an aim of certain embodiments of the present invention to provide a glass dome-shaped touch area which can be fixed to the surface of a touch sensor to create a non-moving touch interactive gaming button.

It is an aim of certain embodiments of the present invention to provide a user interaction module that can be retrofitted to existing touchscreen devices.

According to a first aspect of the present invention there is provided an interactive device comprising
a base display element,
the base display element comprising one or more sensors to detect a user touch, and
a user interaction element mounted to the base display element,
the user interaction element being configured to facilitate at least partial control of the device by user touch,
at least part of the user interaction element protruding outwardly from a surface of the base display element,
the user interaction element being fixed relative to the base display element.

Because the user interaction element protrudes outwardly from the surface of the base display element, the user interaction element provides a user with tactile feedback or feel. This is especially important when placing a final bet and interacting with a game. A standalone touchscreen would not provide the same level of tactile feel or interaction for a user due to its monolithic flat surface with no raised areas.

The user interaction element is held in a fixed position relative to the base display element. The user interaction element is non-movable relative to the base display element. Because the user interaction element is fixed relative to the base display element and is not movable relative to the base display element, the user interaction element will not be subject to damage, or wear, or water ingress between the user interaction element and the base display element, or ingress of dust or dirt between the user interaction element and the base display element. Because the user interaction element is not an up/down moving mechanical part, the user interaction element will not be prone to wearing out in the manner of a conventional ‘bash’ button switch. The user interaction element will not be subject to mechanical failure, or water and/or dirt ingress which could cause a conventional ‘bash’ button switch to stick, or become intermittent during long term use.

The user interaction element may be a separately formed component from the base display element, and the user interaction element may be attached to the base display element to mount the user interaction element to the base display element. The user interaction element may be integrally formed with at least part of the base display element to mount the user interaction element to the base display element.

The base display element may comprise a display, and a first control part for receiving a user touch, the first control part being configured to facilitate at least partial control of the device by user touch. The user interaction element may be mounted to an upper surface of the first control part. At least part of the user interaction element may protrude outwardly from an upper surface of the first control part.

Aptly the user interaction element is of a capacitive coupling material to facilitate the one or more sensors detecting a user touch to the user interaction element. This enables the sensors on the base display element to detect the user touch without any sensors being required in the user interaction element.

The first control part may be of a capacitive coupling material to facilitate the one or more sensors detecting a user touch to the first control part.

Aptly the device comprises a control element to detect a user touch by determining a change in capacitance based on one or more signals from the one or more sensors. Aptly the control element is configured to determine a change in capacitance by comparing the one or more signals relative to one or more pre-defined threshold values. Aptly the control element is configured to detect a user touch to the base display element by comparing one or more signals from a first set of sensors relative to a first pre-defined threshold value, and the control element is configured to detect a user touch to the user interaction element by comparing one or more signals from a second set of sensors relative to a second pre-defined threshold value. Because of the depth of the user interaction element, the signal generated by the set of sensors responsive to a user touch to the user interaction element may be less than the signal generated by the other set of sensors responsive to a user touch to the base display element. By employing two pre-defined threshold values, the device of the invention may account for these different signals to accurately detect a user touch to either the user interaction element or to the base display element.

Aptly the first pre-defined threshold value is greater than the second pre-defined threshold value. Aptly the control element is configured to compare an averaged signal value from the second set of sensors relative to the second pre-defined threshold value. By comparing the averaged signal value, the device of the invention ensures a more stable reading is obtained.

Aptly the control element is configured to perform high pass filtering of the averaged signal value. By performing the high pass filtering, this enables the device of the invention to detect a tap or downward push of a hand or finger of the user on the user interaction element. This also enables the device of the invention to detect when a user rests a hand or finger on the user interaction element, then lifts the hand/finger off of the user interaction element, and then taps or pushes down on the user interaction element again. This action of resting, lifting off, and then tapping or pushing down the hand/finger again is known in digital gaming devices as ‘riding the button’.

Aptly the user interaction element is of a transparent material. In this manner the user may view the part of the base display element beneath the user interaction element. The first control part may be of a transparent material.

Aptly the user interaction element is of a non-metallic material. The first control part may be of a non-metallic material. Aptly the user interaction element is of a glass material, such as standard window glass, or soda lime, or low iron glass, or bora silica. The first control part may be of a glass material. Alternatively the user interaction element may be of a plastic material such as polycarbonate or acrylic, or of any other suitable material. Aptly the user interaction element is uncoated. The user interaction element may not be coated in a conductor, such as a metal conductor. The first control part may be uncoated.

Aptly the user interaction element comprises a base part for mounting to the base display element, and a second control part for receiving a user touch. The second control part may be configured to facilitate at least partial control of the device by user touch. Aptly the depth of the user interaction element from the base part to the second control part is less than 20 mm. Aptly the depth of the user interaction element from the base part to the second control part is greater than 5 mm. Aptly the depth of the user interaction element from the base part to the second control part is between 6 mm and 12 mm.

The user interaction element may comprise a third control part for receiving a user touch, the first control part being configured to facilitate a first type of control of the device by user touch at the first control part, the second control part being configured to facilitate a second type of control of the device by user touch at the second control part, the third control part being configured to facilitate a third type of control of the device by user touch at the third control part. The second type of control may result in a different operation of the device to the third type of control. The first type of control may result in the same operation of the device as the third type of control.

Aptly the user interaction element is dome shaped. The device of the invention enhances the signal generated by a user touch on the area of the dome to accurately detect the user touch notwithstanding the greater thickness at the dome. Alternatively the user interaction element may be or round, or square, or triangular, or any other suitable shape.

The first control part may be planar shaped. The user interaction element may comprise a recess part. The recess part may be ring-shaped. The second control part may be located in a central region of the user interaction element. The third control part may be located in the region of the recess part.

Aptly the user interaction element is fixedly attached to the base display element by laminating a base surface of the user interaction element to an upper surface of the base display element.

Aptly the base display element comprises an active display part, and the user interaction element is mounted to the active display part. The user interaction element may be mounted to the first control part. Aptly the base display element comprises an active display part and an inactive support part, and the user interaction element is mounted to the inactive support part. The user interaction element may be attached to any suitable point of the base display element.

Aptly the base display element comprises a wire based touch screen.

According to a second aspect of the present invention there is provided an interactive gaming device. Alternatively the interactive device of the invention may be employed for other types of applications such as a kiosk, and/or a self-service checkout, and/or a vending machine, and/or an audio-visual mixing device.

According to a third aspect of the present invention there is provided a computer program product comprising computer program code capable of causing a computer system to control an interactive device of the first aspect of the invention when the computer program product is run on a computer system.

Aptly the computer program product is embodied on a record medium, or on a carrier signal, or on a read-only memory.

Certain embodiments of the present invention provide a touch screen interactive device which provides tactile feedback and/or a tactile feel to a user.

Certain embodiments of the present invention provide a touch screen interactive device which reduces the wear and/or failure related issues associated with conventional moving ‘bash’ button switches.

Certain embodiments of the present invention provide a touch screen interactive device which reduces sealable issues associated with moving parts, for example with conventional “bash” button switches.

Certain embodiments of the present invention provide a raised area of a touch screen which is able to detect touch stimulus and isolate such touch stimulus from noise even when the distance between a sensor and the raised surface is relatively large and when the surface is relatively thick.

Embodiments of the present invention will now be described hereinafter, by way of example only, with reference to the accompanying drawings in which:

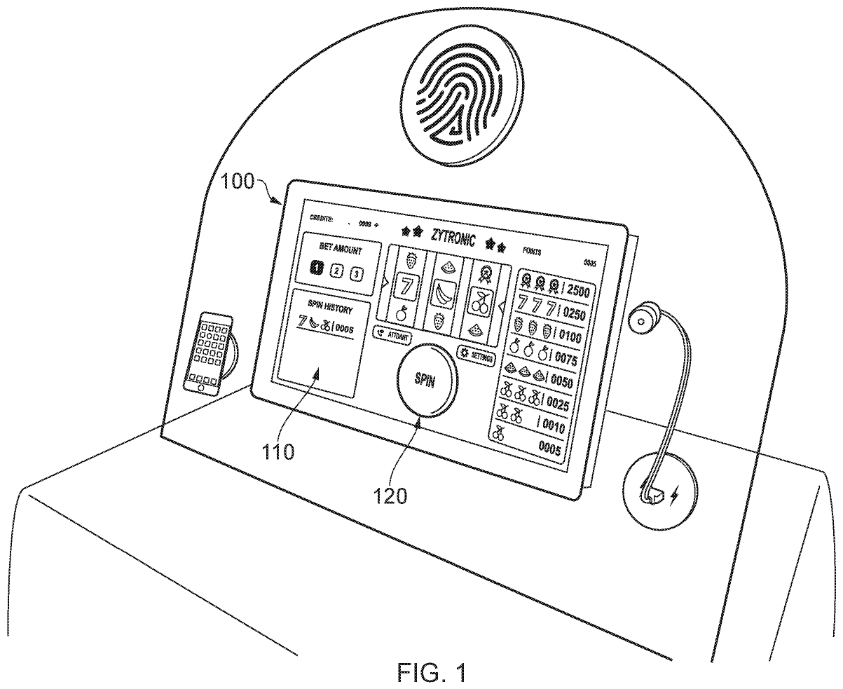

FIG. 1 illustrates a perspective view of an interactive device according to the invention;

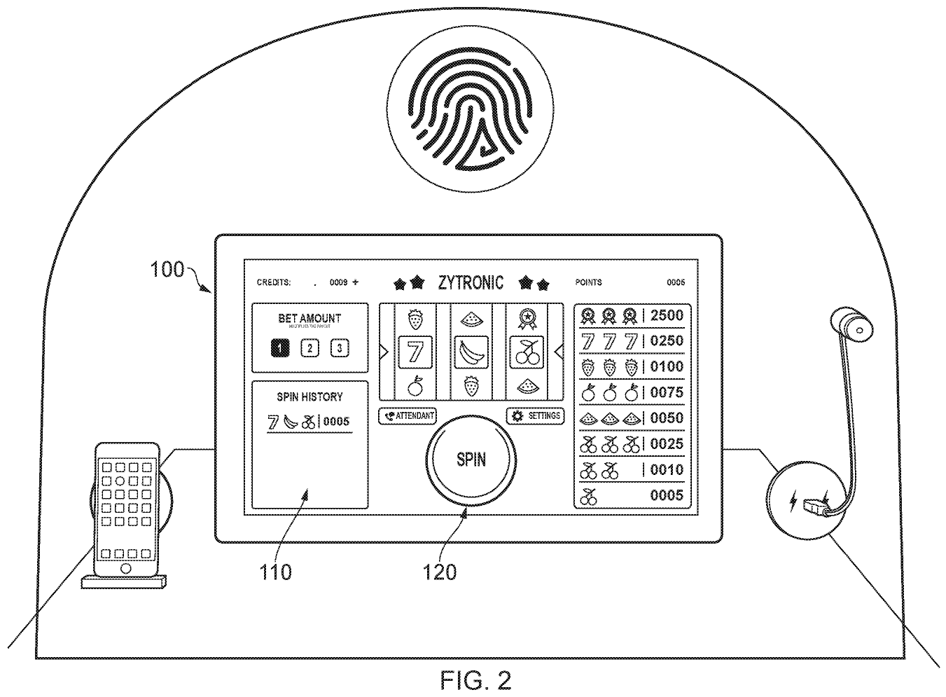

FIG. 2 illustrates a front view of the interactive device of FIG. 1;

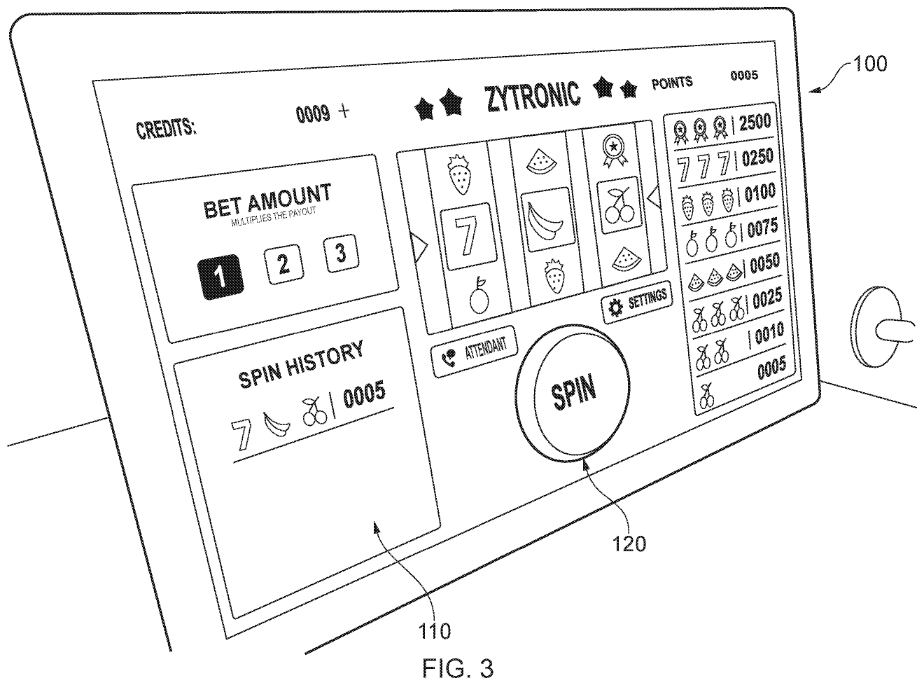

FIG. 3 illustrates a further perspective view of part of the interactive device of FIGS. 1 and 2;

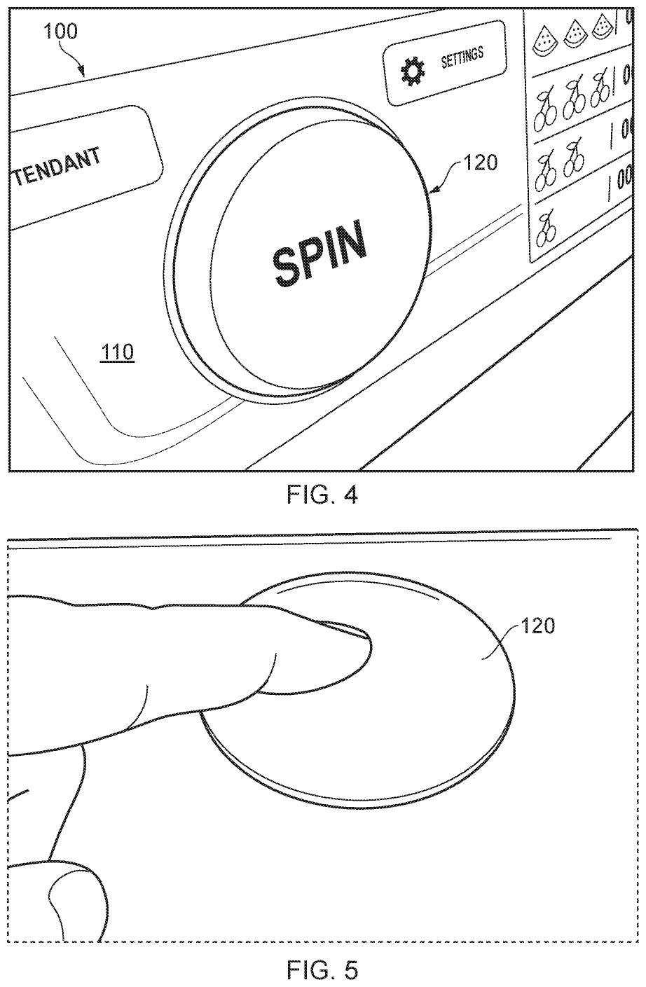

FIG. 4 illustrates a perspective view of a user interaction element of the interactive device of FIGS. 1, 2 and 3 in more detail;

FIG. 5 illustrates a perspective view of an isolated user interaction element;

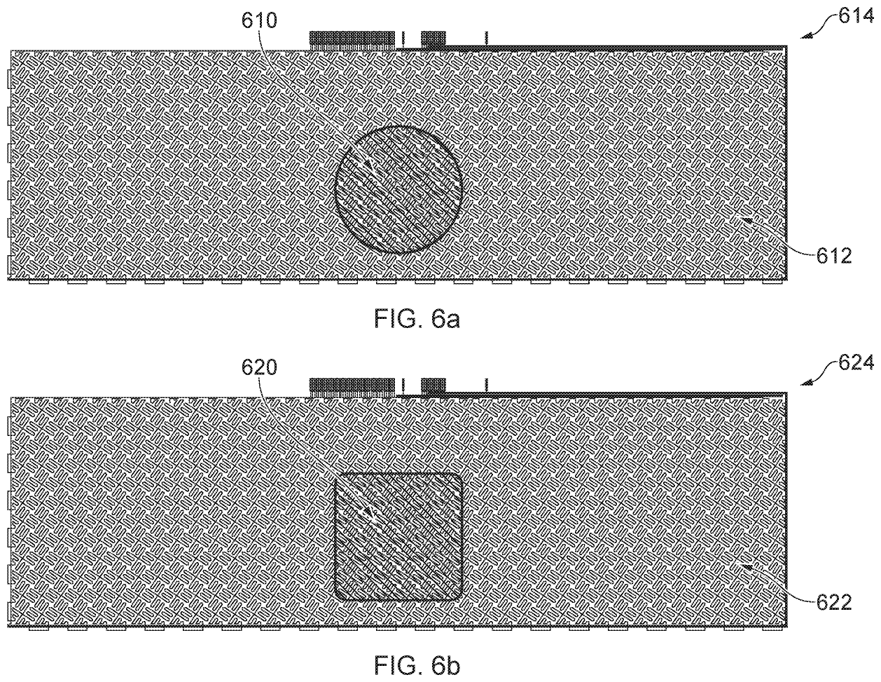

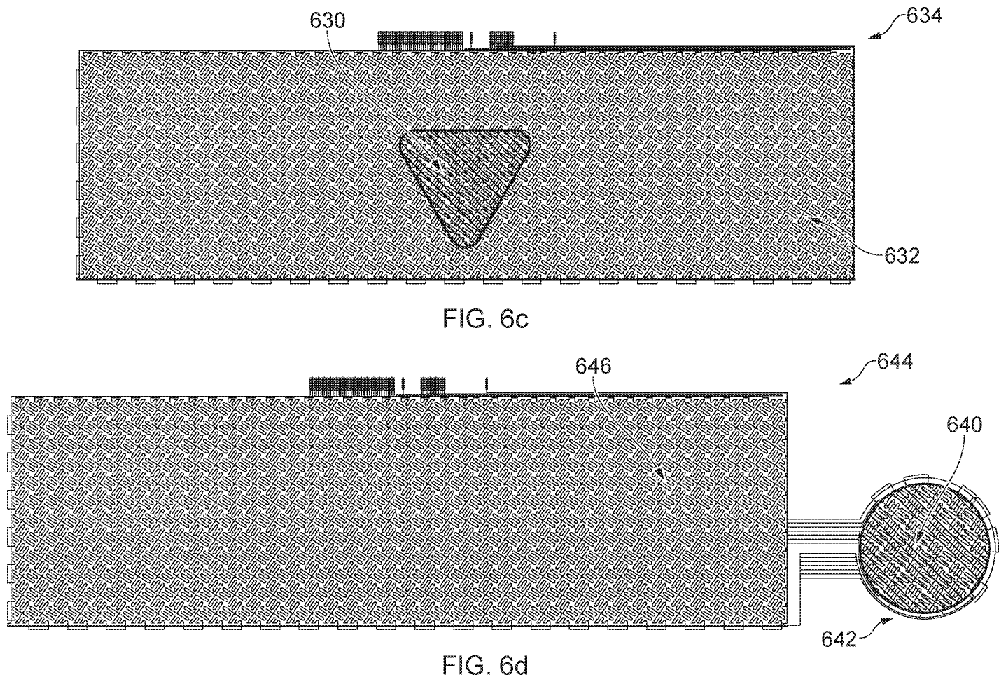

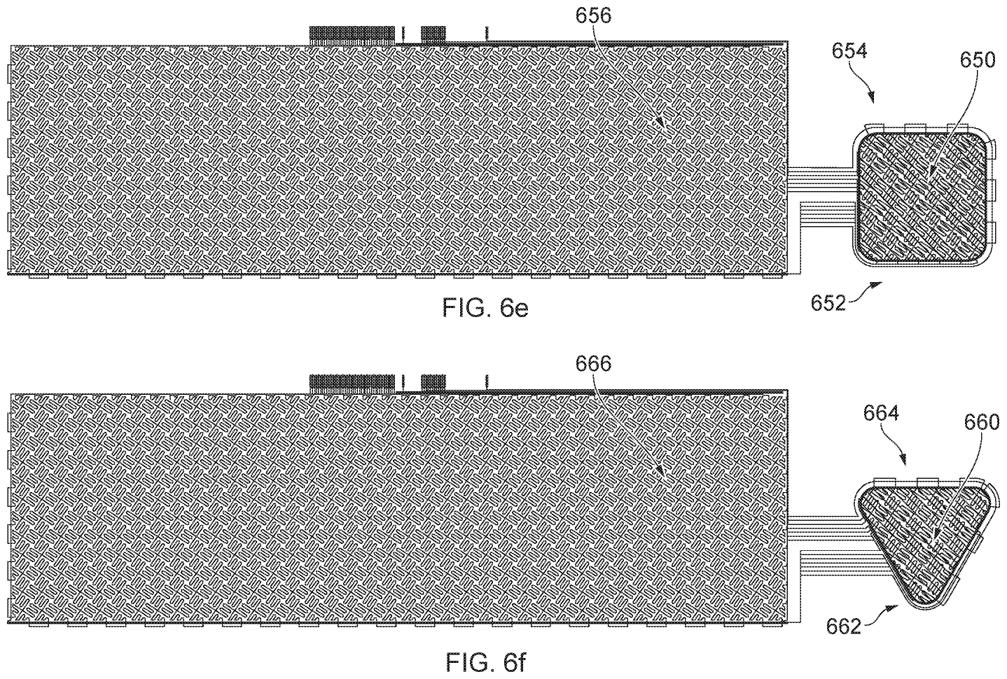

FIGS. 6a-6f illustrate a variety of different shapes and/or arrangements of user interaction elements with respect to a base display element of further interactive devices according to the invention;

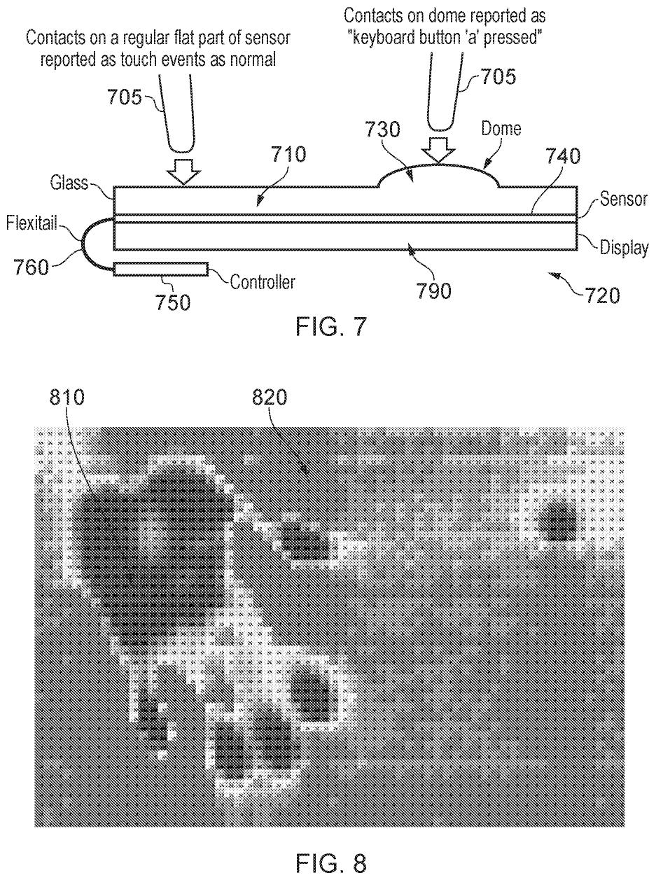

FIG. 7 illustrates a user interacting with a base display element and a user interaction element of a further interactive device according to the invention;

FIG. 8 illustrates a detected touch stimulus incident on an interactive device according to the invention;

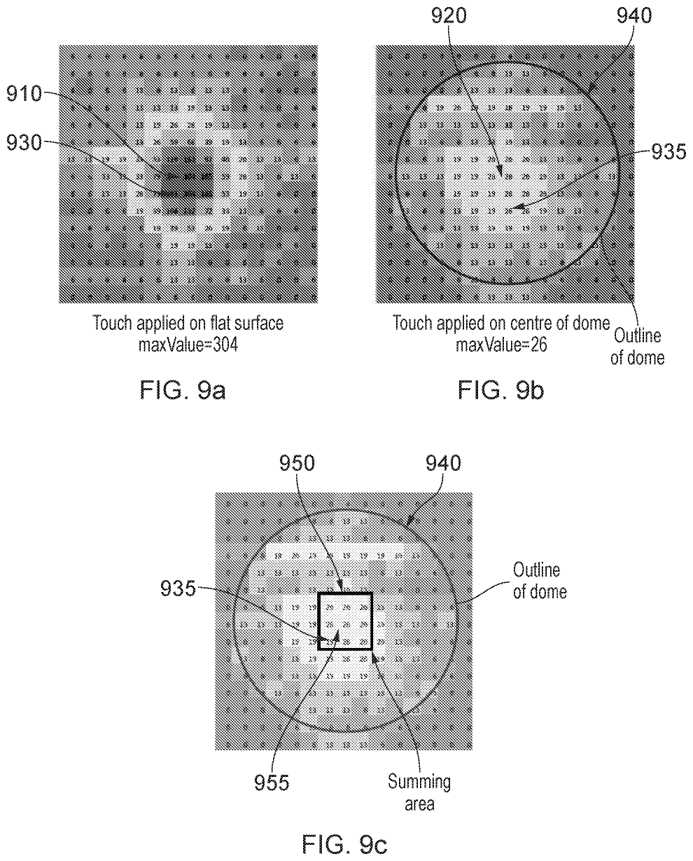

FIG. 9a illustrates a first touch stimuli incident on the base display element;

FIG. 9b illustrates a further touch stimuli incident on a raised user interaction element;

FIG. 9c illustrates a sensor area corresponding to a position of the user interaction element of FIG. 9b in more detail;

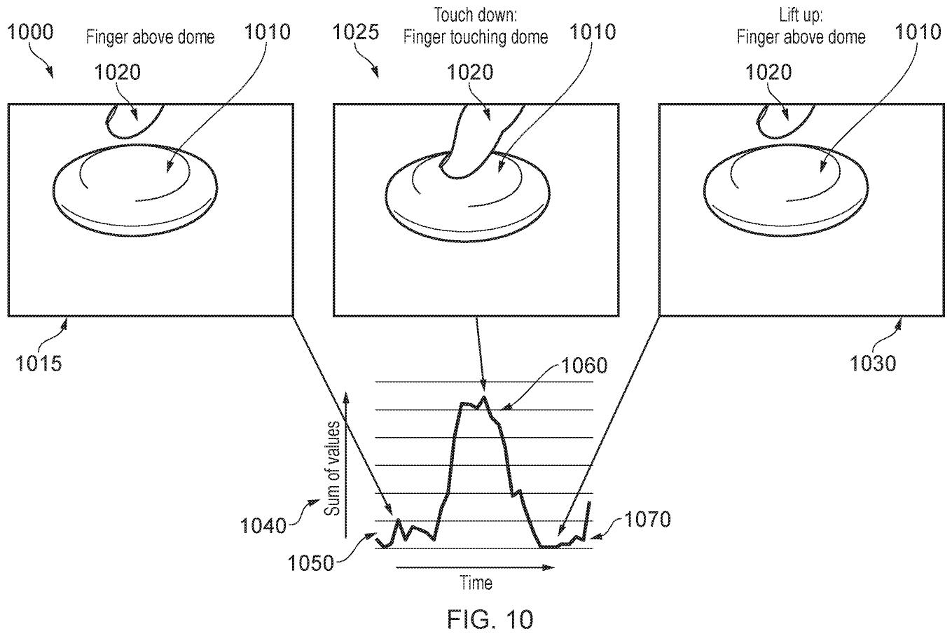

FIG. 10 illustrates a first type of stimulus incident on a user interaction element;

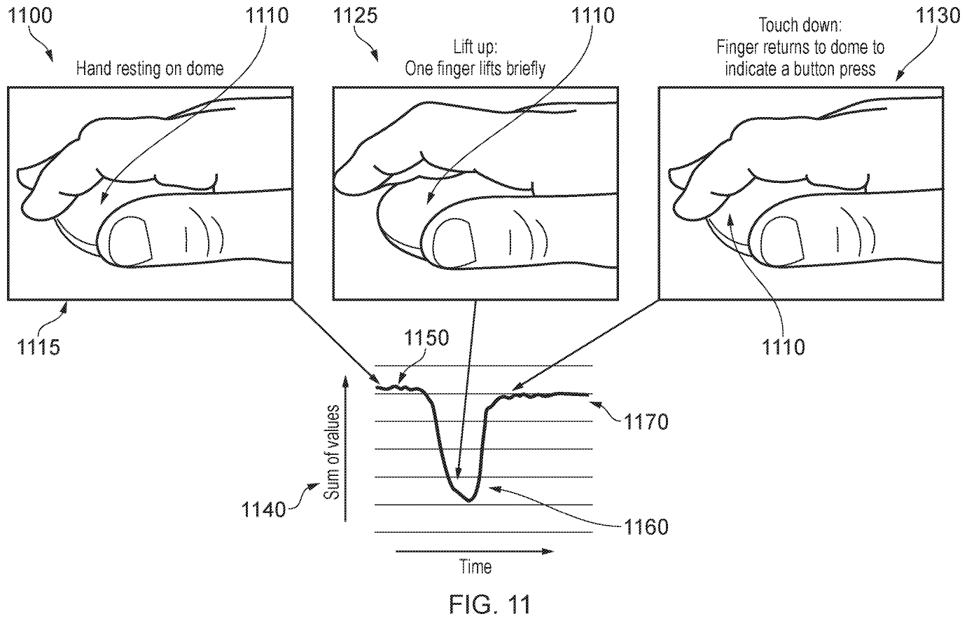

FIG. 11 illustrates a further type of stimulus incident on a user interaction element;

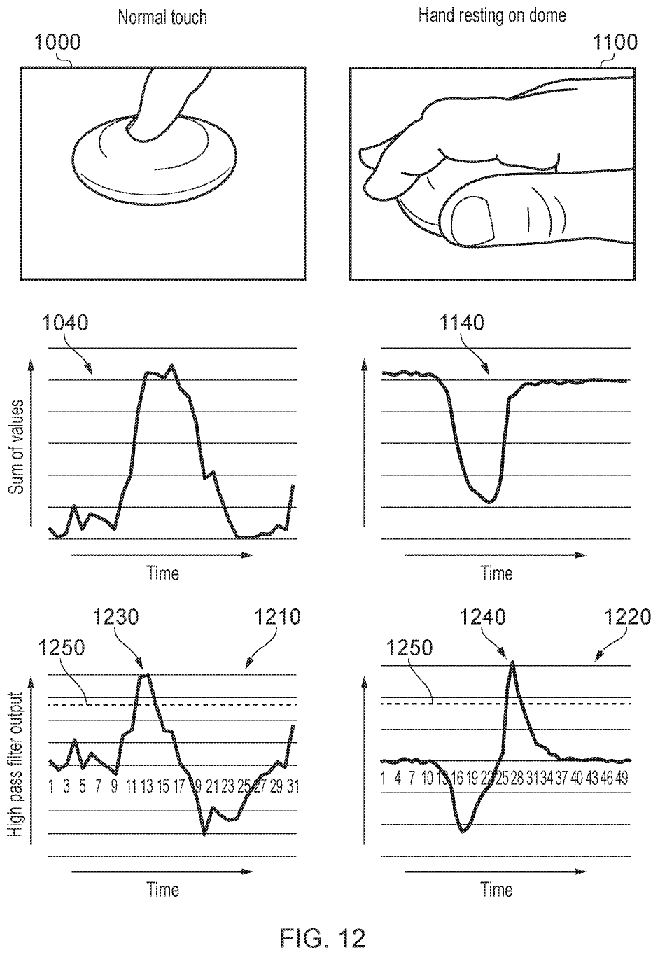

FIG. 12 illustrates the detection of a button press for both a first and further type of stimulus;

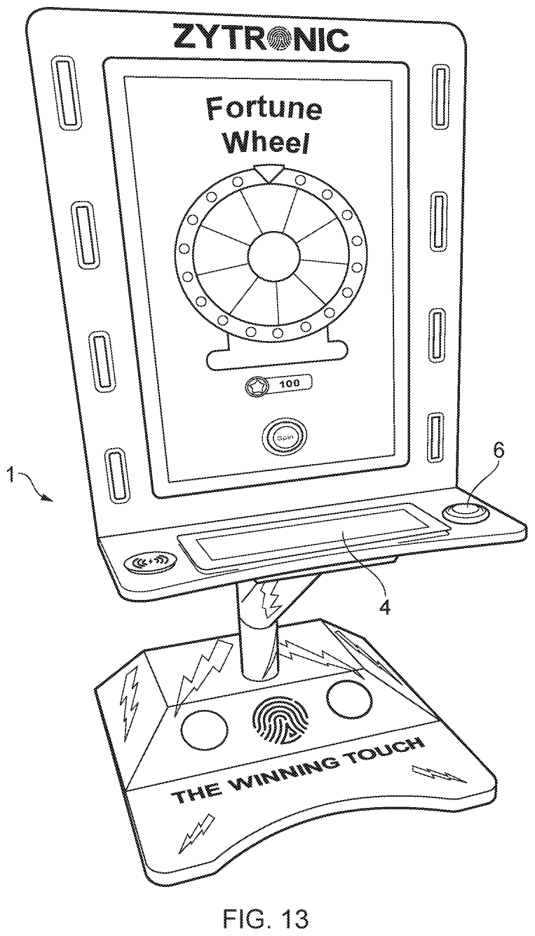

FIG. 13 is a perspective view of another interactive device according to the invention;

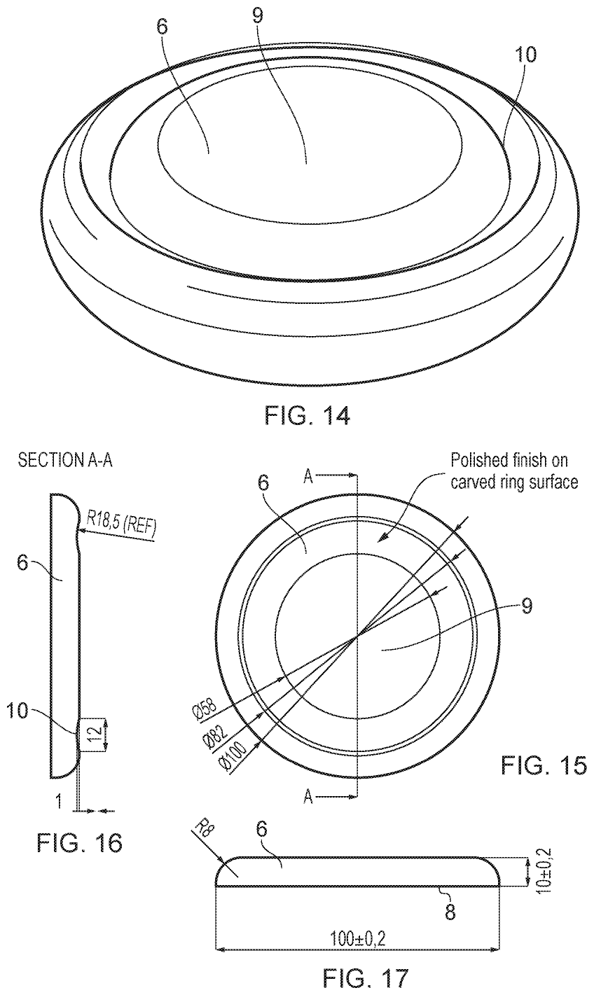

FIG. 14 is a perspective view of a user interaction element of the interactive device of FIG. 13;

FIG. 15 is a plan view of the user interaction element of FIG. 14;

FIG. 16 is a view along line A-A in FIG. 15;

FIG. 17 is a front view of the user interaction element of FIG. 14;

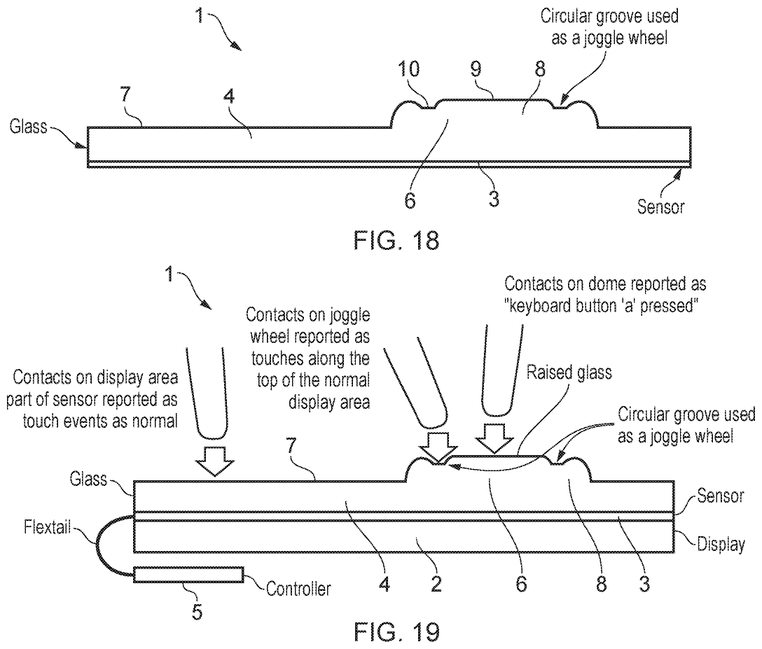

FIG. 18 is a cross-sectional front view of part of the interactive device of FIG. 13;

FIG. 19 is a cross-sectional front view of part of the interactive device of FIG. 13 in use;

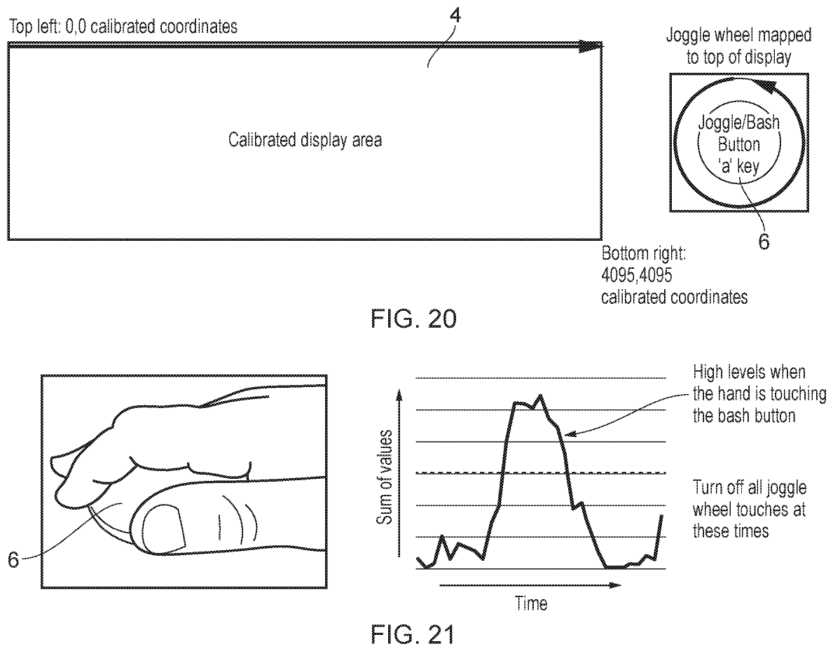

FIG. 20 is a schematic view of the user interaction element and a first control part of the interactive device of FIG. 13; and

FIG. 21 illustrates a sensor signal for the interactive device of FIG. 13 in use.

In the drawings like reference numerals refer to like parts.

FIG. 1 illustrates an interactive device 100. It will be understood that the interactive device 100 of FIG. 1 is a touchscreen gaming device. The touchscreen gaming device includes a screen 110. The screen 110 of FIG. 1 is an LCD display screen. It will be understood that the screen 110 is an example of a display surface. Aptly the display may be part of gaming device, or kiosk, or self-service checkout, or vending machine, or vending ATM machine, or audio-visual mixing device, or medical device or any type of interface. It will be appreciated that any other screen and/or touchscreen display may instead be utilised. It will be appreciated that the screen may be flat, curved or have any other suitable profile. It will also be appreciated that the screen can be mounted vertically or horizontally. The screen 110 is made from glass, however any other suitable material can be used such as polymeric/plastic materials and the like. It will be appreciated that one or more sensors are arranged beneath the screen 110 to facilitate the touch screen operation of the interactive device 100. It will be appreciated that a plurality of sensors may be arranged beneath the screen 110 in a grid-like or matrix-like arrangement. It will be appreciated that a continuous sensor may be arranged beneath the screen 110. The screen and the sensors are included in a base display element. The screen thus constitutes a display surface of the base display element. The touchscreen gaming device also includes a user interaction element 120. The user interaction element 120 enables a user to control interactive device 100 by user touch to the user interaction element 120. The user interaction element 120 is raised relative to the screen 110. That is to say that the user interaction element 120 extends outwardly from the screen 110. The user interaction element 120 of FIG. 1 is attached to the screen 110. It will however be appreciated that the user interaction element may instead be an integral part of the screen (the screen and the user interaction element being integrally formed) and thus protrudes outwardly from the rest of the screen.

The user interaction element 120 of FIG. 1 is substantially dome shaped and is substantially convex in a direction extending out from the screen 110 of the interactive device 100. It will be appreciated that other shapes of user interaction element could be utilised, for example, substantially triangular, substantially square, substantially circular and the like. It will be appreciated that any shape of user interaction element may include a somewhat convex profile such that the face/surface of the user interaction element is curved. That is to say that the user interaction element may be dome shaped, or round, or square, or triangular or any other shape. The user interaction element 120 of FIG. 1 is of glass. It will be understood that the user interaction element may be made from standard glass, such as standard window glass, or from soda lime, or low iron glass, or bora silica and the like. Alternatively the user interaction element may be plastic, for example polycarbonate or acrylic and the like. The user interaction element may be manufactured from any other suitable polymer or polymeric material.

It will be understood that FIG. 1 illustrates an example of a raise domed area within a LCD visible area mounted to the front of a touch sensor overlay to create a “SPIN” touch area.

It will be understood that the raised object can be made from glass or plastic (acrylic, polycarbonate) and can be adhered to the surface of a touch sensor in any location either within the visible area of the LCD or outside the visible LCD area.

It will be understood that the raised user interaction element can be retrofitted to existing touchscreen devices.

As shown in FIG. 1, the user interaction element 120 is not coated in a conductor. It will be understood that the user interaction element 120 cooperates with at least one sensor located underneath the user interaction element and located underneath the screen such that the user interaction element functions as a touchscreen. It will be understood that the sensor/sensors are located distal to the surface of the user interaction element 120 when compared with the relative positions of the sensor/sensors and the screen 110, the screen also functioning as a touchscreen. The user interaction element 120 thus does not require a conductive coating to compensate for an increased distance between the sensor/sensors and the surface of the user interaction element 120.

The user interaction element 120 is attached or affixed to the display surface (or the screen 110 in FIG. 1) of the base display element. The user interaction element 120 is attached to the screen 110 by laminating a base surface of the user interaction element 120 to the screen 110 outer surface. It will be understood that laminating can be achieved using a resin, for example PVB (Polyvinyl butyral) or Polyurethane or the like. The resin can be fused to the base surface of the user interaction element and display surface of the base display element using autoclaving and the like. The user interaction element 120 of FIG. 1 is attached to a lower central point of the display surface of the base display element. It will however be appreciated that the user interaction element may instead be attached to any point of the base display element, for example at a side of the display surface of the base display element. The user interaction module may instead be attached to a portion of the base display element that is not the display surface or screen 110. Furthermore, it will be understood that while FIG. 1 illustrates a single user interaction element 120, a plurality of user interaction elements may be attached to the base display element.

Because the user interaction element 120 is fixed relative to the base display element 110 and is not movable relative to the base display element 110, the user interaction element 120 will not be subject to damage, or water ingress between the user interaction element 120 and the base display element 110, or ingress of dust or dirt between the user interaction element 120 and the base display element 110.

Aptly the user interaction element 120 can be laminated to the front of the sensor/display surface 110 using either UV curved optically clear resin or via a hot autoclave/pressure method using interlayer materials laminated between the touch sensor surface and the rear of the raised user interaction element 120, such as Polyurethane (PU) or Polyvinyl butyral (PVB). Such interlay materials create a rigid bond between the surface of the touch sensor 110 and the raised user interaction element 120 to prevent the user interaction element 120 from being removed, hence giving the raised user interaction element 120 an integrated feel on the surface of the touch sensor 110. Aptly the raised user interaction element 120 can be formed from moulding or machining (front glass or plastics) into various raised shapes (round, domed, triangular, square etc) to provide the desired look and feel of the raised area. Aptly the raised user interaction element 120 is generally made from a transparent material such as glass, polycarbonate or acrylic. This creates a see-through object that when placed in front of the touch sensor 110 in front of the LCD creates a lens effect, to magnify the graphical connect displayed on the LCD under the touchscreen 110 and raised user interaction element 120, visible to the user. Aptly the raised user interaction element 120 may alternatively be non-transparent and made from materials such as wood, ceramic, non-transparent plastic, printed glass.

It will be understood that the raised user interaction element 120 does not need to have a conductive coating applied to its surface to allow it to be touch active. Aptly the raised user interaction element 120 can be placed either within the main active area of the touch sensor/LCD 110 or can be placed remotely outside the visible area of the LCD 110. To facilitate different arrangements of the user interaction element, the configuration of the touch sensor electrode arrangement may be modified to provide electrodes under wherever the raised user interaction element is situated.

FIG. 2 illustrates a front view of the interactive device of FIG. 1.

FIG. 3 illustrates a still further perspective view of the interactive device of FIGS. 1 and 2.

FIG. 4 illustrates the user interaction element 120 of FIGS. 1, 2, and 3 in more detail. As illustrated in FIG. 4, the user interaction element 120 is substantially dome shaped and extends out from the display surface 110 of the base display element 100 in a convex manner. It will be appreciated that the base region of the user interaction element 120, that is attached to the display surface 110 by lamination, is substantially circular. As illustrated in FIG. 4, the user display element 120 is a spin button for the electronic touchscreen gaming device 100 that includes the base display element 110. It will be understood that the user interaction element 120 is a touch screen operable button and is responsive to the touch of a user's finger or hand or the like. Optionally the user interaction element 120 may be responsive to a change in contact of a user stimulus.

FIG. 5 illustrates an isolated user interaction element 120. As indicated in FIG. 5, the user interaction element 120 is substantially dome-shaped. It will be appreciated that the user interaction element 120 of FIG. 5 may be analogous to the user interaction element of FIGS. 1, 2, 3 and 4.

FIGS. 6a to 6f illustrate a variety of different shapes and/or arrangements of user interaction elements with respect to the base display element.

It will be understood that FIGS. 6a to 6c show various shaped raised user interaction elements mounted to the touch active display area of the touch sensor. FIG. 6a illustrates a substantially circular user interaction element 610 arranged at a central region of a display surface 612 of a base display element 614. FIG. 6b illustrates a substantially square user interaction element 620 arranged at a central region of a display surface 622 of a base display element 624. FIG. 6c illustrates a substantially triangular user interaction element 630 arranged at a central region of a display surface 632 of a base display element 634. It will be appreciated that any other suitable shape of user interaction element could instead be utilised. Aptly, the user display element 610, 620, 630 may be arranged at any other desired position on the display surface 612, 622, 632 of the base display element 614, 624, 634, for example at a side or at a corner of the display surface.

It will be understood that FIGS. 6d to 6f show various shaped raised user interaction elements mounted to an inactive support part of the touch sensor. FIG. 6d illustrates a substantially circular user interaction element 640 arranged at a portion 642 of a base display element 644 to a side of a display surface 646 of the base display element 644. FIG. 6e illustrates a substantially square user interaction element 650 arranged at a portion 652 of a base display element 654 to a side of a display surface 656 of the base display element 654. FIG. 6f illustrates a substantially triangular user interaction element 660 arranged at a portion 662 of a base display element 664 to a side of a display surface 666 of the base display element 664.

It will be understood that FIGS. 6d to 6f also illustrate examples of how electrodes could be arranged to run out to areas outside the main visible area 646, 656, 666 of the LCD touch screen to create electrodes under an area with the remotely mounted raised user interaction element areas 640, 650, 660.

FIG. 7 illustrates a user 705 interacting with a touch screen display surface 710 of a base display element 720 alongside a user 705 interacting with a user interaction element 730. The base display element 720 includes a screen 710, at least one sensor 740 located beneath the screen 710, a display 790, a controller 750 governing user touch detection and recognition, and a flexitail 760 or other suitable cabling connecting the controller 750 to the base display element 720. The image to be displayed is generated on the display 790. The display 790 is located beneath the sensor 740. The screen 710 is provided in this case in the form of a glass overlay of the touch sensor. The screen 710 is the surface which the user touches to operate the base display element 720. It will be understood that the user interaction element 730 is affixed to the base display element 720. As illustrated in FIG. 7, the user 705 can interact with the base display element 720 by touching the display surface 710 and/or the user interaction element 730 via a finger and the like. The controller 750 detects a user touch by determining a change in capacitance based on signals from the sensors 740. In particular the controller 750 determines a change in capacitance by comparing the signals relative to pre-defined threshold values. The controller 750 may detect a user touch to the display surface 710 of the base display element 720 by comparing signals from a first set of sensors relative to a first pre-defined threshold value, and the controller 750 may detect a user touch to the user interaction element 730 by comparing signals from a second set of sensors relative to a second pre-defined threshold value. The first pre-defined threshold value is greater than the second pre-defined threshold value.

FIG. 8 illustrates a detected touch stimulus 810 incident on a touchscreen display surface of a base display element. The touch stimulus is in the form of a user handprint in contact with the display surface. As indicated with respect to FIG. 7, the touchscreen display surface includes a glass screen. Optionally the screen may be made from any other suitable material. A sensor or sensor array is arranged on the rear surface of the screen. The touch sensor includes an array of transmit and receive electrodes 820 laid out in a grid on the rear of the sensor glass. It will be understood that the electrodes 820 may be arranged in a matrix-like manner. In response to a user touching the display surface, the capacitance changes at that point of the surface changes. Such a capacitance change is detected by the sensor and thus the capacitance values measured by the controller change at the touched locations. Such changed capacitance values represent the handprint 810 of the user in FIG. 8. It will be appreciated that the detection of a touch stimulus is governed by sensor data being transmitted to the controller which passes the data through a detection algorithm to determine if a touch stimulus has been detected.

FIG. 9a illustrates a first touch stimuli 910 incident on a display surface of the base display element. FIG. 9b illustrates a further touch stimuli 920 incident on the raised user interaction element fixed to the base display element. It will be appreciated that the user interaction element of FIG. 9b may be analogous to the user interaction element of any previous Figure. As illustrated in FIG. 9a, the touch stimuli incident on the display surface yields a large capacitive response as detected by the electrode array 930 of the sensor of the base display element. In contrast, the touch stimuli incident on the user interaction element yields a much smaller capacitive response as detected by the sensor electrode array. In fact, for a touch stimulus incident on the user interaction element, each individual signal may be comparable to the low magnitude noise level. This is due to the increased physical spacing between the user touch stimulus on the user interaction element and the sensor/sensor array relative to the distance between the display surface and the sensor due to the outward protrusion of the user interaction element. A thickness of the user interaction element may also contribute to this reduced response magnitude. It will thus be appreciated that touch signals are much lower when the touch is on the raised dome than when it is on flat glass area.

Given the reduced magnitude of touch detection at the user interaction element, a detection algorithm associated with the detection of touch stimuli incident on the base display element averages/sums the detected values of capacitance, and/or any other suitable variable, across all or some electrodes in a sensor area 935 corresponding to the area of the user interaction element to provide a more stable reading/detection of touch stimulus. It will be appreciated that the algorithm may be performed by a controller, a computer, a server or the like. In this manner the algorithm enhances the touch on the area of the user interaction element to recognise the touch to account for the greater thickness (distance between the sensor and the user interaction element) at the position of the user interaction element. For example the depth of the user interaction element from a base part mounted to the base display element to a control part which receives a user touch may be between 6 mm and 12 mm. It will be understood that the outwardly protruding user interaction element may be substantially dome shaped. An outline of a sensor area corresponding to a position of such a dome shaped user interaction element is indicted by the circle 940 in FIG. 9b.

FIG. 9c illustrates the sensor area 935 corresponding to a position of the dome shaped user interaction element 940 in more detail. The square 950 in FIG. 9c illustrates a summing area 955 of the sensor where values provided by the electrodes contained within this summing area 955 are to be summed. The summed value is less sensitive to background noise levels. In the example provided in FIG. 9c, the dome shaped user interaction element has a diameter of 75 mm, the cell size is 6 mm, and the summing area is 3×3 cells under the centre of the dome shaped user interaction element. The resulting response magnitude in the example illustrated in FIG. 9c is thus 227.

FIG. 10 illustrates a first type of stimulus 1000 incident on a user interaction element 1010. It will be appreciated that the first type of stimulus is analogous to a button press. At step 1 1015 of the first type of stimulus, a user 1020 is in a non-contact state with respect to the user interaction element 1010. At step 2 1025 of the first type of stimulus the user 1020 contacts the surface of the user interaction element 1010. In the example shown in FIG. 10 the user 1020 contacts the user interaction element 1010 with a finger but it will be appreciated that the user 1020 may contact the user interaction element 1010 via any suitable body part or other mechanism. At step 3 1030 of the first type of stimulus, the user 1020 returns to a non-contact state by removing the finger from the user interaction element 1010. FIG. 10 also illustrates a representative sensor output 1040 throughout the first type of stimulus. The sensor output is plotted graphically as a sum of sensor/electrode values (as described in FIG. 9) against time. At step 1 1015 of the first type of stimulus, the sum of sensor values remains relatively constant (with the exception of noise) at a baseline value 1050. At step 2 1025 of the first type of stimulus, when the user 1020 contacts the user interaction element 1010, a sharp increase in the sum of sensor values is observed forming a sharp peak 1060. At step 3 1030 of the first type of stimulus, when the user 1020 disconnects from the user interaction element 1010, the sum of sensor values returns to the baseline value and subsequently remains constant 1070.

FIG. 11 illustrates a further type of stimulus 1100 incident on a user interaction element 1110. The further type of stimulus is known in a gaming environment as “riding the button” and is also analogous to a button press. At step 1 1115 of the further type of stimulus, a user is in a contact state with respect to the user interaction element 1110. That is to say that the use is remaining in substantially constant contact with the user interaction element 1110 with no substantial change in said contact. At step 2 1125 of the further type of stimulus the user progresses into a modified contact state with respect to the surface of the user interaction element 1110. In the example shown in FIG. 11 the modified contact state includes the user lifting up a single finger from the user interaction element 1110. At step 3 1130 of the further type of stimulus, a user returns to a contact state by recontacting the aforementioned finger to the user interaction element 1110. FIG. 11 also illustrates a representative sensor output 1140 throughout the further type of stimulus. The sensor output is plotted graphically as a sum of sensor/electrode values (as described in FIG. 9) against time. At step 1 1115 of the further type of stimulus, the sum of sensor values remains constant at a baseline value 1150. At step 2 1125 of the further type of stimulus, when the user lifts the finger from the user interaction element 1110, a sharp decrease in the sum of sensor values is observed forming a sharp inverse peak 1160. At step 3 1130 of the further type of stimulus, when the user replaces the finger on the user interaction element 1110, the sum of sensor values returns to the baseline value and subsequently remains constant 1170.

FIG. 12 illustrates the detection of a button press for both the first 1000 and further 1100 type of stimulus. In order to determine if a button press has occurred via the user interaction element, the sensor output 1040, 1140 is passed through a high pass filter. High pass filtering allows the device to recognise a push down by finger (first type of button press 1000) or riding the button wherein a hand sits on button, a finger lifts off and then depresses again (further type of button press 1100). FIG. 12 illustrates high pass filter outputs 1210, 1220 for the first 1000 and further 1100 type of stimulus. The high pass filter outputs 1210, 1220 both yield a high positive magnitude 1230, 1240 signal for both the first 1000 and further 1100 type of stimulus. A threshold 1250 is applied such that the computer algorithm responsible for detecting user interaction with the user interaction element such that any output signal from the high pass filter stage that exceeds this threshold is considered to constitute a button press. Exceeding the threshold is considered to be a touch on the dome and the associated algorithm subsequently reports that keyboard button press has occurred. As illustrated in FIG. 12, the magnitude output from the high pass filter corresponds with step 2 1025 for the first type of stimulus 1000 and step 3 1130 for the further type of stimulus 1100. This is consistent with user expectations of when they have pressed the button. The high pass filter is optionally a first order high pass filter with time constant of 100 ms.

Referring to FIGS. 13 to 21 there is illustrated another interactive gaming device 1 according to the invention. The interactive gaming device 1 comprises a base display element, a user interaction element 6, and a controller 5 (FIG. 19).

The base display element comprises a display 2, a first control part 4 for receiving a user touch, and sensors 3 to detect the user touch (FIG. 19). In this case the base display element is provided in the form of a wire based touch screen.

The first control part 4 is of a capacitive coupling material to facilitate the sensors 3 detecting the user touch to the first control part 4. The first control part 4 is provided in the form of a transparent, non-metallic material. In this case first control part 4 is provided in the form of a glass material. The first control part 4 is uncoated.

The first control part 4 is planar shaped (FIG. 19).

The user interaction element 6 is mounted to the base display element. The user interaction element 6 is held in a fixed position relative to the base display element and is non-movable relative to the base display element. In this case the user interaction element 6 is a separately formed component from the base display element, and the user interaction element 6 is attached to the base display element. In particular the user interaction element 6 is attached to an upper surface 7 of the first control part 4. For example the user interaction element 6 may be fixedly attached to the upper surface 7 of the first control part 4 by laminating a base surface 8 of the user interaction element 6 to the upper surface 7 of the first control part 4.

It will be appreciated that the user interaction element 6 may be mounted to the base display element in a variety of different manners. For example the user interaction element 6 may be integrally formed with at least part of the base display element. In one case the user interaction element 6 may be integrally formed with the first control part 4.

The user interaction element 6 protrudes outwardly from a surface of the base display element. In particular the user interaction element 6 protrudes outwardly from the upper surface 7 of the first control part 4 (FIG. 19).

The user interaction element 6 facilitates control of the device 1 by means of a user touch on the user interaction element 6. The user interaction element 6 is of a capacitive coupling material to facilitate the sensors 3 detecting a user touch to the user interaction element 6. The user interaction element 6 is provided in the form of a transparent, non-metallic material. In this case the user interaction element 6 is provided in the form of a glass material. The user interaction element 6 is uncoated.

The user interaction element 6 comprises a base part 8 fixedly attached to the upper surface 7 of the first control part 4, a second control part 9 for receiving a user touch, and a third control part 10 for receiving a user touch (FIG. 18). The second control part 9 is located in a central region of the user interaction element 6. The third control part 10 is provided in the form of a ring-shaped recess. The recess groove 10 surrounds the button 9. The grooved indent 10 is inboard from the edge of the raised glass bash button 9. The third control part 10 may be polished to give a gliding, frictionless feel.

It will be appreciated that the dimensions of the user interaction element 6 may vary. For example the glass raised area 6 may be 10 mm thick, the groove 10 may be 12 mm diameter and 1 to 2 mm deep.

The first control part 4 facilitates a first type of control of the device 1 by the user touch at the first control part 4. The second control part 9 facilitates a second type of control of the device 1 by the user touch at the second control part 9. The second type of control may detect touch via a central bash button action. The third control part 10 facilitates a third type of control of the device 1 by the user touch at the third control part 10. The third type of control may detect touch as an outer joggle wheel action on the grooved joggle wheel 10 using a standard touch algorithm. The first type of control may result in the same operation of the device 1 as the third type of control. The third type of control may present the coordinates detected from the joggle wheel 10 at the top edge of the main display sensor 4 to read these co-ordinates from the joggle wheel 10 as a separate function.

The depth of the user interaction element 6 from the base part 8 to the second control part 9 may be less than 20 mm. The depth of the user interaction element 6 from the base part 8 to the second control part 9 may be greater than 5 mm. In this case the depth of the user interaction element 6 from the base part 8 to the second control part 9 is between 6 mm and 12 mm.

The controller 5 detects a user touch by determining a change in capacitance based on signals from the sensors 3. The controller 5 determines the change in capacitance by comparing the signals relative to pre-defined threshold values. In particular the controller 5 detects the user touch to the first control part 4 by comparing signals from a first set of sensors relative to a first pre-defined threshold value. The controller 5 detects the user touch to the user interaction element 6 by comparing an averaged signal value from a second set of sensors relative to a second pre-defined threshold value. In this case the first pre-defined threshold value is greater than the second pre-defined threshold value.

Because of the depth of the user interaction element 6, the signal generated by the second set of sensors responsive to the user touch to the user interaction element 6 may be less than the signal generated by the first set of sensors responsive to the user touch to the first control part 4. By employing two pre-defined threshold values, the device 1 of the invention may account for these different signals to accurately detect a user touch to either the user interaction element 6 or to the first control part 4.

By comparing the averaged signal value, the device 1 of the invention ensures a more stable reading is obtained.

In another embodiment the controller 5 may perform high pass filtering of the averaged signal value. By performing the high pass filtering, this enables the device 1 of the invention to detect a tap or downward push of a hand or finger of the user on the user interaction element 6. This also enables the device 1 of the invention to detect when a user rests a hand or finger on the user interaction element 6, then lifts the hand/finger off of the user interaction element 6, and then taps or pushes down on the user interaction element 6 again. This action of resting, lifting off, and then tapping or pushing down the hand/finger again is known in digital gaming devices as ‘riding the button’.

FIG. 14 illustrates the raised interactive button detection with the joggle wheel 10.

FIGS. 15 to 17 illustrate the circular carved ring button 6 with the joggle wheel 10. The dimensions are in mm. It will be appreciated that these dimensions are merely examples. The invention is not limited to the illustrated dimensions.

FIG. 18 illustrates the sensors 3, the first control part 4, and the user interaction element 6 in further detail.

The device 1 enables identification and reporting of precise movements in the event of reduced signal levels. By using the summing of the signal values and the high pass filter, accurate results may be achieved even with low signal levels. To detect the precise location around the joggle wheel 10, or multiple touches to the joggle wheel 10, the touch algorithm of the first control part 4 is employed. A lower touch threshold is employed due to the thicker glass in this area of the user interaction element 6.

FIG. 19 illustrates how to represent joggle wheel touches to a host controller 5 or database or server.

FIG. 20 illustrates touch reporting. As an example contacts on the bash button 9 may be reported as a keyboard character “a”. Touches to the non-button part 10 of the sensor may be reported as touches to the first control part 4. In particular touches around the joggle wheel 10 may be reported as locations along the top of the display 4. As an example top left may be reported for a touch just left of top of the joggle wheel 10. As an example moving right may be reported for a touch moving anti-clockwise around the joggle wheel 10. As an example top right may be reported for a touch just right of the top of the joggle wheel 10.

FIG. 21 illustrates how the joggle wheel 10 may be turned off when there is a hand on the bash button 9. In particular detection of joggle wheel touches may be turned off when the bash button sum of values is above a pre-defined threshold level.

It will be understood that the system of FIGS. 1 to 21 allows for enhancement of touch sensing under a raised user interaction element area to project a stronger sensing field through the raised user interaction element to allow touch detection through a thicker overlay material.

A method of detecting a touch stimulus on a raised user interaction element, with reference to FIGS. 1 to 21, thus includes gathering data from an incident touch stimulus via sensors, summing values obtained in a sensor region corresponding to the user interaction element, applying a high pass filter to the summed values, determining that the output of the high pass filter is above a threshold value and reporting ‘a’ key output to the host that a button has been pressed.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An interactive device comprising:
a base display element,
the base display element comprising one or more sensors to detect a user touch, and
a user interaction element mounted to the base display element,
the user interaction element being configured to facilitate at least partial control of the device by user touch,
at least part of the user interaction element protruding outwardly from a surface of the base display element, and
the user interaction element being fixed relative to the base display element.

2. The device as claimed in claim 1 wherein the user interaction element is a separately formed component from the base display element, and the user interaction element is attached to the base display element to mount the user interaction element to the base display element, or wherein the user interaction element is integrally formed with at least part of the base display element to mount the user interaction element to the base display element.

3. (canceled)

4. The device as claimed in claim 1, wherein the base display element comprises a display, and a first control part for receiving a user touch, the first control part being configured to facilitate at least partial control of the device by user touch.

5-6. (canceled)

7. The device as claimed in claim 1, wherein the user interaction element is of a capacitive coupling material to facilitate the one or more sensors detecting a user touch to the user interaction element.

8. The device as claimed in claim 4, wherein the first control part is of a capacitive coupling material to facilitate the one or more sensors detecting a user touch to the first control part.

9. The device as claimed in claim 1, wherein the device comprises a control element to detect a user touch by determining a change in capacitance based on one or more signals from the one or more sensors.

10. The device as claimed in claim 9 wherein the control element is configured to determine a change in capacitance by comparing the one or more signals relative to one or more pre-defined threshold values.

11. The device as claimed in claim 10 wherein the control element is configured to detect a user touch to the base display element by comparing one or more signals from a first set of sensors relative to a first pre-defined threshold value, and the control element is configured to detect a user touch to the user interaction element by comparing one or more signals from a second set of sensors relative to a second pre-defined threshold value.

12. The device as claimed in claim 11 wherein the first pre-defined threshold value is greater than the second pre-defined threshold value.

13. The device as claimed in claim 11 wherein the control element is configured to compare an averaged signal value from the second set of sensors relative to the second pre-defined threshold value.

14. The device as claimed in claim 13 wherein the control element is configured to perform high pass filtering of the averaged signal value.

15-22. (canceled)

23. The device as claimed in claim 1, wherein the user interaction element comprises a base part for mounting to the base display element, and a second control part for receiving a user touch.

24. The device as claimed in claim 23 wherein the second control part is configured to facilitate at least partial control of the device by user touch.

25-27. (canceled)

28. The device as claimed in claim 4, wherein the user interaction element comprises a second control part for receiving a user touch and a third control part for receiving a user touch, the first control part being configured to facilitate a first type of control of the device by user touch at the first control part, the second control part being configured to facilitate a second type of control of the device by user touch at the second control part, the third control part being configured to facilitate a third type of control of the device by user touch at the third control part.

29. The device as claimed in claim 28 wherein the second type of control results in a different operation of the device to the third type of control.

30. The device as claimed in claim 28 wherein the first type of control results in the same operation of the device as the third type of control.

31-32. (canceled)

33. The device as claimed in claim 1, wherein the user interaction element comprises a recess part.

34-38. (canceled)

39. The device as claimed in claim 1 wherein the base display element comprises an inactive support part, and the user interaction element is mounted to the inactive support part.

40. The device as claimed in claim 1, wherein the base display element comprises a touch screen.

41. (canceled)

42. A computer program product comprising computer program code capable of causing a computer system to control the interactive device as claimed in claim 1, when the computer program product is run on a computer system.

43. (canceled)
